(19) United States
(12) Patent Application Publication
(10) Pub. No.: US 2008/0114597 A1
(43) Pub. Date: May 15, 2008

(54) METHOD AND APPARATUS

(76) Inventor: Evgeny Karpov, Tampere (FI)

Correspondence Address: PERMAN & GREEN, 425 POST ROAD, FAIRFIELD, CT, 06824, US

(21) Appl. No.: 11/559,694

(22) Filed: Nov. 14, 2006

(51) Int. Cl. G10L 15/00

(52) U.S. Cl. 704/251; 704/E15.001

(57) ABSTRACT

Several modes for improving dictation are provided when entering information into an information processing apparatus. Instead of using a conventional, state-of-the-art, approach where a user typically only dictate full sentences and later correct the errors made during the speech recognition, the invention provides several alternative modes regarding how to process speech input. The mode alternatives may be changed by the user when he/she gets more experienced with dictation. Moreover, the system itself will be more adapted to the voice of each particular user that uses the device.

### FIELD OF THE INVENTION

The disclosed embodiments relate to a method in an information processing apparatus for controlling input of information, for example for use in a mobile communication terminal, an apparatus configured to perform such a method as well as a computer program performing such a method.

### BACKGROUND

At the moment speech recognition, often referred to as automatic speech recognition (ASR), is used widely in different types of apparatuses, such as mobile communication terminals. Speech recognition applications are becoming more and more attractive for users as current technology is getting more mature and embedded devices are equipped with increasing computational power and memory. There exists speaker (i.e. user) dependent speech recognition technology in products from at least one manufacturer of mobile telephones. Also, there exist mobile communication terminals that are provided with speaker independent speech recognition features.

However, ASR technology is far from being perfect and recognition errors will continue to be a problem in the foreseeable future. Therefore, it is important to minimize any impact of incorrect recognition, not least for the convenience of the user.

The idea of mobile dictation is, for example, to provide an alternative way of information (e.g. text) input for personal communication devices with limited size and keyboard facilities, or even no conventional input at all. By providing a robust speech recognition system it may be possible to manufacture smaller devices by simply removing the possibility of keyboard input, by not providing a keyboard, or at least minimizing it.

State-of-the-art embedded speech recognition systems for command and control (e.g., name dialing) can reach a performance level of 95-99%. However, free dictation is a much more demanding task. The average accuracy of current embedded dictation systems is in the range of 75% to 90% at the word level. Many factors may affect performance, like speaking style, noise level and so on. The best performance can be achieved by limiting the dictation domain (e.g. personal communication style of messages) resulting in a relatively small and accurate language model, and by using the device in an acoustically clean environment.

In the Samsung P207 communication device, error correction can be done only after dictation is over. By selecting a specific key combination, utilizing the keyboard, it will display a list of alternatives for each current word. Moreover, speech input features are available in the Compaq iPaq Pocket PC, but the functionality is rather command and control than dictation. Error correction in Compaq iPaq Pocket PC is performed by way of actuation of a touch screen with the use of a stylus.

### SUMMARY OF THE INVENTION

It would be advantageous to overcome the drawbacks relating to the prior art devices as discussed above.

Hence, in a first aspect there is provided a method in an information processing apparatus for controlling input of information. The method comprises recording utterances of speech, providing the utterances to a speech recognition engine, receiving interpreted information from the speech recognition engine, displaying the interpreted information. The speech recognition engine operates in a current operational mode selected from a plurality of operational modes and each operational mode is associated with respective operational parameters that define how to interpret the utterances and how to display interpreted information. The selection of the current mode of operation is performed in response to a user action detected during displaying of interpreted information.

In a second aspect, there is provided an information processing apparatus comprising a processor, a memory, a microphone and a display. These are configured to control input of information by recording utterances of speech, providing the utterances to a speech recognition engine, receiving interpreted information from the speech recognition engine, displaying the interpreted information. The speech recognition engine is configured to operate in a current operational mode selected from a plurality of operational modes and each operational mode is associated with respective operational parameters that define how to interpret the utterances and how to display interpreted information. The apparatus is further configured such that the selection of the current mode of operation is performed in response to a user action detected during displaying of interpreted information.

In a third aspect, there is provided a computer program comprising software instructions that, when executed in a computer, performs the method discussed above.

In other words, several modes are provided for improving dictation when entering information into an information processing apparatus. Instead of using a conventional, state-of-the-art, approach where a user typically only dictate full sentences and later correct the errors made during the speech recognition, the invention provides several alternative modes regarding how to process speech input. The mode alternatives may be changed by the user when he/she gets more experienced with dictation. Moreover, the system itself will be more adapted to the voice of each particular user that uses the device.

One operational mode of the speech recognition engine may be a full sentence recognition mode where a full sentence of words is recognized and displayed, whereupon an editing operational mode is activated during which editing actions are detected.

Another operational mode of the speech recognition engine may be a word by word recognition mode where individual words are recognized and for each recognized word at least one candidate word is displayed and a word selection action is detected.

Yet another operational mode of the speech recognition engine may be an auto correction recognition mode where individual words are recognized and concatenated to a current sentence, during which recognition and concatenation an operation of sentence context recognition operates to recognize the current sentence.

In other words, in the full sentence mode, when a user speaks a full sentence, a transcription (i.e. the interpreted information) is generated that may have errors. The user then corrects them.

In the word by word mode, a user dictates words in an isolated manner, i.e. with distinct pauses between individual words. After each new word is detected by the system (using e.g. voice activity detection) and processed by the speech recognition engine, the user is given a list of best candidate words that he/she may select. The options may be sorted according to scores given to them by the recognition engine. If there is no correct word in the candidate list, the user may close the list of candidate words and dictate the word again. The word candidate list could be automatically closed after predefined time-out if there is no action from the user automatically selecting best candidate word, thereby minimizing the number of user actions, such as key clicks, that are needed. The recognition engine may be set also to decide based on confidence estimate whether or not the list needs to be shown, or if a word could be inserted automatically, thus allowing fast dictation speed with user confirmation only when necessary.

The auto correction mode is similar to the word by word mode. However, instead of requiring correction/confirmation from the user for every word, the user is allowed to dictate several words, even if an erroneous recognition has occurred. Then, based on the recent word context, the operation proceeds by returning by attempting to correct earlier errors in an automatic manner. To put it another way, a future word context is utilized for automatic correction of a word.

The invention provides a number of advantages. For example, between users the recognition rate may differ dramatically, depending on the voice of the speaker, his/her accent, style of speaking etc. Performance may be good for some users but provide totally wrong results for another. Then, by providing several options in the inventive manner, i.e. selectable modes of operation, a benefit is gained by providing fast dictation speed for users whose speech can be easily recognized, but still providing at least a possibility for other users, whose speech is less recognizable, to use dictation. Continuous adaptation during usage is provided and after a period of time even hard to recognize speech may be recognized in fast full sentence mode.

Furthermore, in conventional systems, when a result is displayed to a user after the user has finished dictation, the result may in some cases be a totally wrong sentence simply because only a few words have been misrecognized and a best sentence was selected due to the language model being incorrect. By providing several dictation modes in the inventive manner, it is possible to avoid such situation.

### BRIEF DESCRIPTION OF THE DRAWINGS

FIG. 1 shows schematically a block diagram of a communication terminal according to one embodiment.

FIG. 2 is a flow chart illustrating a number of steps of a method according to one embodiment.

### PREFERRED EMBODIMENTS

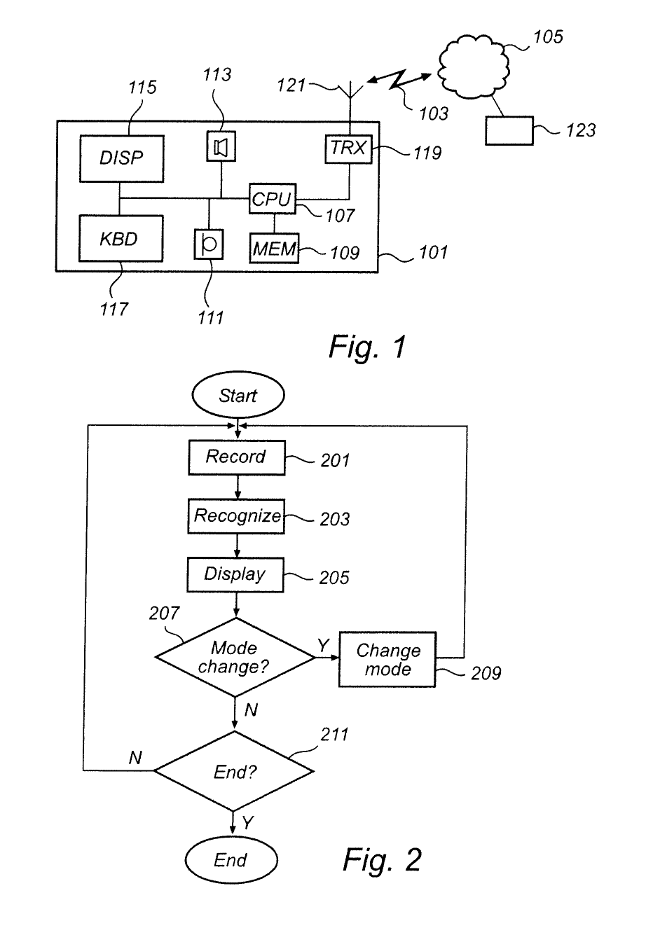

FIG. 1 illustrates schematically a communication terminal 101 in which the disclosed embodiment can be implemented. The terminal 101 is capable of communication via an air interface 103 with a radio communication system 105 such as the well known systems GSM/GPRS, UMTS, CDMA 2000 etc. The terminal comprises a processor 107, memory 109 as well as input/output units in the form of a microphone 111, a speaker 113, a display 115 and a keyboard 117. Radio communication is realized by radio circuitry 119 and an antenna 121. The details regarding how these units communicate are known to the skilled person and is therefore not discussed further.

The communication terminal 101 may for example be a mobile telephone terminal or a PDA equipped with radio communication means. The method according to the disclosed embodiments will in general reside in the form of software instructions together with other software components necessary for the operation of the terminal 101, in the memory 109 of the terminal. Any type of conventional removable memory is possible, such as a diskette, a hard drive, a semi-permanent storage chip such as a flash memory card or “memory stick” etc. The software instructions of the inventive notification function may be provided into the memory 109 in a number of ways, including distribution via the network 105 from a software supplier 123. That is, the program code of the invention may also be considered as a form of transmitted signal, such as a stream of data communicated via the Internet or any other type of communication network, including cellular radio communication networks of any kind, such as GSM/GPRS, UMTS, CDMA 2000 etc.

Turning now to FIG. 2, a method according to one embodiment will be described in terms of a number of steps to be taken by controlling software in a terminal such as the terminal 101 described above in connection with FIG. 1. The exemplifying method starts at a point in time when an application has been started that requires text input, such as a messaging application in the form of an e-mail, SMS or MMS application. As summarized above, the terminal is at this point in time ready to perform automatic speech recognition (ASR) according to any of three different modes of operation. An initial mode may be preset by way of data stored in the terminal, e.g. in the form of a data item in a user profile or by way of an explicit selection by a user.

During the execution of the method, as will be described below, user interface software, executing in the terminal, detects user actions such as activation of keypad keys and soft keys and provides appropriate signals to the executing method, as is known in the art. Processing of detected user actions is performed as described below.

In a recording step 201, utterances of speech are recorded and transformed into a digital representation suitable for further processing. The digitally represented utterances are recognized in a recognition step 203 in a speech recognition engine. The speech recognition engine is typically also executed in the terminal, however other alternatives may be possible including the use of a remote server connected to the terminal via a communication network. The recognized utterances are displayed in a display step 205. The manner in which the displaying is performed, i.e. individual words, lists of words etc., is governed by the current mode of operation of the ASR.

Any detected user action during the steps of recording 201, recognizing 203 and displaying 205 is analyzed and acted upon in a decision step 207. If a mode change is detected, i.e. a selection of a different mode than the current mode, the selected mode is effectuated in a change mode step 209 and the process continues with recording, recognizing and displaying as described above. If, in the decision step 207, it is found that the current mode shall remain, a check is made in a decision step 211 whether a user action has been detected that indicates that the process shall be terminated. If that is the case, the process is terminated, otherwise process continues with recording, recognizing and displaying as described above.

As summarized above, the three modes are full sentence recognition mode, word by word recognition mode and auto correction recognition mode.

In the full sentence recognition mode, a user can speak full sentences without waiting for reaction from the terminal. To indicate that the method is operating and waiting for speech, a cursor may be displayed on a terminal display that changes appearance from a blinking to a rotating line, for example. The user does not have to wait for recognized words to be displayed. When recognition is done, the system will change to an editing state in which the user is allowed to replace incorrectly recognized words, as is known in the art. Words may or may not be displayed during the dictation. After recognition is done may be adapted to select a best sentence based on a language model and provide it to a receiving application, such as a message editor.

In the word by word recognition mode, the user is supposed to speak in a “word-by-word” manner, in the sense that he/she speaks one word, waits for a reaction from the terminal, makes a correction if necessary and then speaks next word. Here, a state of waiting state may be graphically indicated on the terminal display by a rotating cursor and by this indicating to the user that speech input is awaited. A processing state may be indicated by a rotating sandglass symbol and thereby informing the user that a word has been detected. A correction state is active when a correction dialog is displayed, during which the user has a possibility to correct a word, or simply wait for an automatic time-out selection and then allowing the process to continue with dictation input and recognition. During the correction state, if the correct word is not displayed, e.g. in a candidate word list, the user may take action by, e.g., pressing a “Cancel” keypad key or soft key. By this, the word will not be provided to the messaging application and a return will be effectuated to the waiting state. If the user does not press any key during a, typically short, period of time, the word will be automatically provided to the messaging application and the process will continue with dictation input and recognition. If an incorrect word was accidentally inserted, the user can go back and change correct word back or delete a whole segment of words. The user may also control a cursor to move between words, if during dictation he/she has decided to insert some words into the message. To minimize the amount of user actions, e.g. key clicks, that are needed and time for selecting a word in a confirmation dialog, the process may also be set to automatically confirm words with high confidence and ask for user confirmation only in uncertain cases.

In the auto correction mode, the process in the terminal attempts to correct misrecognized words based on sentence context. Words are provided to the messaging application one after another when the user proceeds with the message dictation, but recognition mistakes are changed automatically when there more and more words are dictated. Typically, the auto correction mode is implemented by keeping recognition result as a list of connected segments (N-best segments). Each segment contains a list of best candidates obtained after word recognition. When a new segment is available, a whole sentence is rescored based on acoustic score combined with language model probabilities and best candidates are selected and displayed to the user.

1. A method in an information processing apparatus for controlling input of information, comprising:
recording utterances of speech,
providing the utterances to a speech recognition engine,
receiving interpreted information from the speech recognition engine,
displaying the interpreted information,
where:
the speech recognition engine operating in a current operational mode selected from a plurality of operational modes and where each operational mode is associated with respective operational parameters that define how to interpret the utterances and how to display interpreted information, and
the selection of the current mode of operation is performed in response to a user action detected during displaying of interpreted information.

2. The method of claim 1, where an operational mode of the speech recognition engine is a full sentence recognition mode where a full sentence of words is recognized and displayed, whereupon an editing operational mode is activated during which editing actions are detected.

3. The method of claim 1, where an operational mode of the speech recognition engine is a word by word recognition mode where individual words are recognized and for each recognized word at least one candidate word is displayed and a word selection action is detected.

4. The method of claim 1, where an operational mode of the speech recognition engine is an auto correction recognition mode where individual words are recognized and concatenated to a current sentence, during which recognition and concatenation an operation of sentence context recognition operates to recognize the current sentence.

5. The method of claim 1, comprising:
providing the interpreted information to a text editor.

6. The method of claim 1, in a mobile communication apparatus, comprising:
providing the interpreted information to a message editor.

7. An information processing apparatus comprising a processor, a memory, a microphone and a display that are configured to control input of information by:
recording utterances of speech,
providing the utterances to a speech recognition engine,
receiving interpreted information from the speech recognition engine,
displaying the interpreted information,
where:
the speech recognition engine is configured to operate in a current operational mode selected from a plurality of operational modes and configured such that each operational mode is associated with respective operational parameters that define how to interpret the utterances and how to display interpreted information, and
the apparatus is further configured such that selection of the current mode of operation is performed in response to a user action detected during displaying of interpreted information.

8. A mobile communication terminal comprising an information processing apparatus according to claim 7.

9. A computer program comprising software instructions that, when executed in a computer, performs the method of claim 1.
